(19) United States
(12) Patent Application Publication
(10) Pub. No.: US 2025/0284497 A1
(43) Pub. Date: Sep. 11, 2025

(54) SYSTEMS AND METHODS FOR TRACKING OUT-OF-ORDER LOAD OPERATIONS WITH CHECKPOINT BITS OF DATA CACHE TAGS

(71) Applicant: Advanced Micro Devices, Inc., Santa Clara, CA (US)

(72) Inventor: John M. King, Austin, TX (US)

(73) Assignee: Advanced Micro Devices, Inc., Santa Clara, CA (US)

(21) Appl. No.: 17/855,661

(22) Filed: Jun. 30, 2022

(51) Int. Cl. G06F 9/38; G06F 9/30; G06F 9/50

(52) U.S. Cl. CPC G06F 9/3834; G06F 9/3842

(57) ABSTRACT

The disclosed computer-implemented method for tracking out-of-order processor operations utilizing data cache tags can include identifying, in a processor data cache and during program execution, a cacheline that includes a first checkpoint bit and a second checkpoint bit. The method can further include setting one of the first checkpoint bit or the second checkpoint bit of the cacheline based on a second processor operation accessing the cacheline out of order from a first processor operation. In addition, the method can include resynchronizing program execution in response to a triggering event and at least one of the first checkpoint bit or the second checkpoint bit being set. Various other methods, systems, and computer-readable media are also disclosed.

### BACKGROUND

Some example microprocessor load management systems allow for out-of-order execution. For example, example systems can enable microprocessors to execute operations out of order so that microprocessor resources may be more efficiently utilized. Out-of-order operation execution of loads can lead to execution results that violate memory consistency rules when, for example, one operation loads data from a location to which updated data has yet to be written by another core in the system. For this reason, example microprocessor load management systems often include provisions for tracking out-of-order load execution to adhere to the memory consistency rules.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1 is a flow diagram of an exemplary computer-implemented method for tracking out-of-order load operations utilizing data cache tags according to one or more implementations.

FIG. 2 is a diagram of a load management system operating within a processor of a computing device according to one or more implementations.

FIGS. 3A-3C illustrate a load execution example in connection with a conventional load ordering queue according to one or more implementations.

FIG. 4 is a diagram of an example cacheline according to one or more implementations.

FIG. 5 is a sequence progression diagram of the load management system tracking an out-of-order load operation utilizing checkpoint bits within a cacheline tag according to one or more implementations.

FIG. 6 is a sequence progression diagram of the load management system repurposing a load ordering queue to track out-of-order load operations associated with an evicted cacheline according to one or more implementations.

FIG. 7 is a detailed diagram of the load management system according to one or more implementations.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to systems and methods for tracking out-of-order load operation execution with data cache tags. For example, even with the provisions implemented by example microprocessor load management systems for tracking out-of-order operation execution, these example microprocessor load management systems are generally inflexible. For example, in many implementations, example systems track out-of-order load operation executions with a load queue (LDQ) or a special-purposes out-of-order load tracking queue called a load ordering queue (LOQ). When a load operation is executed out of order, example systems may track that load operation with the load queue or load ordering queue to guard against load ordering violations (e.g., such as mentioned above). Despite this, most example systems utilize LDQs or LOQs that are fully associative, and as such, not scalable. Thus, when an example system fills the LDQ or LOQ with out-of-order load operations, load execution within the microprocessor can grind to a halt until more space opens up in the LDQ or LOQ.

Accordingly, the inflexible nature of these example systems can further lead to various processor inefficiencies. For example, rather than utilizing as many processor resources at as much capacity as possible, these example systems force such resources to idle while waiting for LDQ or LOQ space to open up. Given that LDQs and LOQs are generally smaller in size than the data caches from which load operations are executed, a processor under such an example system may waste many clock cycles waiting for out-of-order load operations to complete or retire before beginning the execution of new load operations once more. This waiting can incur significant and undesirable performance penalties.

While example systems rely on a load queue (LDQ) or load ordering queue (LOQ) to track out-of-order load operation execution, the systems and methods described herein can leverage existing tags within cachelines to track whether load operations have been executed out of order. By tracking this information utilizing cacheline tags within a microprocessor data cache, the systems and methods described herein are not limited to the inflexibilities and resulting inefficiencies of an LDQ or LOQ in tracking out-of-order loads.

In more detail, the systems and methods described herein can access one or more cachelines of a processor's data cache. Each accessed cacheline can include a tag and other data. In one or more implementations, the systems and methods described herein can access two checkpoint bits within a cacheline tag as well as processor operations (e.g., load operations, store operations) within the data of a cacheline. In response to detecting an out-of-order load execution of a processor operation within a cacheline, the systems and methods described herein can set a checkpoint bit within that cacheline's tag. The systems and methods described herein can continue to monitor operation execution relative to the cacheline while setting and clearing the two checkpoint bits as operations are executed and retired.

In response to detecting a triggering event relative to the cacheline, the systems and methods described herein can determine whether any of the two checkpoint bits in the cacheline's tag are set. If at least one of the checkpoint bits is set-meaning that there is at least one load operation that was executed out of order and still pending retirement-the systems and methods described herein can resynchronize program execution. In one or more implementations, the systems and methods described herein can resynchronize program execution to ensure that the pending out-of-order operation can re-execute by loading the most up-to-date data.

In one or more implementations, the systems and methods discussed herein can further re-purpose the LOQ to track out-of-order loads from evicted cachelines. For example, while a victim cacheline can no longer have a location in a data cache, the systems and methods discussed herein can allocate space within the LOQ for the evicted cacheline in response to determining that at least one of the checkpoint bits of that cacheline are set. The systems and methods discussed herein can then utilize the LOQ to track the evicted cacheline out-of-order loads until retirement to ensure that there are no load ordering violations relative to the evicted cacheline.

As such, the systems and methods discussed herein provide solutions to technical problems presented by example load management systems. For example, rather than being limited to the size of a conventional LDQ or LOQ for out-of-order load management, the systems and methods discussed herein present an out-of-order load management solution that is more flexibly associated with the size of the processor data cache. In this way, the systems and methods discussed herein can track a maximum number of out-of-order loads for as many as all of the cachelines in the data cache, plus additional cachelines that have been evicted from the data cache but are still able to be tracked by the LOQ.

In addition to this improved level of scalability, the systems and methods discussed herein also improve the efficient use of processor resources. For example, the systems and methods discussed herein can efficiently utilize an existing data structure within the cachelines of the processor data cache to track out-of-order load processing rather than repeatedly allocating and de-allocating LOQ entries. Moreover, because of the flexibility presented by the systems and methods discussed herein, additional computing resources are not wasted in idling while additional LDQ or LOQ space opens up. Instead, the systems and methods discussed herein provide an out-of-order tracking solution that can potentially track out-of-order loads from every cacheline in the data cache--meaning no processor resources are wasted idling while waiting for additional tracking space opens up.

As will be described in greater detail below, the present disclosure describes various systems and methods for tracking out-of-order load operations with data cache tags. For example, in one implementation, a method can include identifying, in a processor data cache and during program execution, a cacheline including at least a first checkpoint bit and a second checkpoint bit, and setting one of the first checkpoint bit or the second checkpoint bit of the cacheline based on a second processor operation accessing the cacheline out of order from a first processor operation. The method can further include resynchronizing the program execution in response to a triggering event and at least one of the first checkpoint bit or the second checkpoint bit being set.

In one or more implementations, the method can further include, prior to resynchronizing the program execution, allocating a load ordering queue entry for the cacheline based on the triggering event being an eviction of the cacheline from the processor data cache, and at least one of the first checkpoint bit or the second checkpoint bit being set.

In at least one implementation, the cacheline is accessed by additional processor operations. Additionally, the first processor operation and a first subset of the additional processor operations are associated with a first wrap bit value, and the second processor operation and a second subset of the additional processor operations are associated with a second wrap bit value.

In one or more implementations, the method can further include re-setting at least one of the first checkpoint bit or the second checkpoint bit based on retirement of the second processor operation and the at least one of the first checkpoint bit or the second checkpoint bit being associated with the second processor operation. In one implementation, the second processor operation is retired based on a wrap bit value associated with the second processor operation.

In one or more implementations, the method can further include executing an additional processor operation from the first subset of additional processor operations out of order and setting the first checkpoint bit of the cacheline based on the additional processor operation from the first subset of additional processor operations being associated with the first checkpoint bit. Additionally, the method can further include executing an additional processor operation from the second subset of additional processor operations out of order, setting the second checkpoint bit of the cacheline, and re-setting the second checkpoint bit of the cacheline upon retirement of the additional processor operation from the second subset of additional processor operations.

In at least one implementation, resynchronizing the program execution includes re-executing the second processor operation, identifying any further processor operations that executed in connection with the second processor operation, and re-executing the further processor operations. Additionally, in at least one implementation, the triggering event is an invalidating probe. Furthermore, in at least one implementation, the first processor operation is a load operation, and the second processor operation is a load operation.

In one example, a processor can include a processor data cache that includes a cacheline including at least a first checkpoint bit and a second checkpoint bit, and a logic layer that causes the processor to perform various acts. For example, the logic layer can cause the processor to perform acts including: identifying, in the processor data cache and during program execution, the cacheline, setting one of the first checkpoint bit or the second checkpoint bit of the cacheline based on a second processor operation accessing the cacheline out of order from a first processor operation, and resynchronizing the program execution in response to a triggering event and at least one of the first checkpoint bit or the second checkpoint bit being set.

In some examples, a system can include at least one processor and a physical memory including computer-executable instructions that, when executed by the at least one processor, cause the at least one processor to perform various acts. For example, the computer-executable instructions can cause the at least one processor to perform acts including identifying, in a processor data cache and during program execution, a cacheline comprising at least a first checkpoint bit and a second checkpoint bit, setting one of the first checkpoint bit or the second checkpoint bit of the cacheline based on a second processor operation accessing the cacheline out of order from a first processor operation, and resynchronizing the program execution in response to a triggering event and at least one of the first checkpoint bit or the second checkpoint bit being set.

Features from any of the implementations described herein can be used in combination with one another in accordance with the general principles described herein. These and other implementations, features, and advantages will be more fully understood upon reading the following detailed description in conjunction with the accompanying drawings and claims.

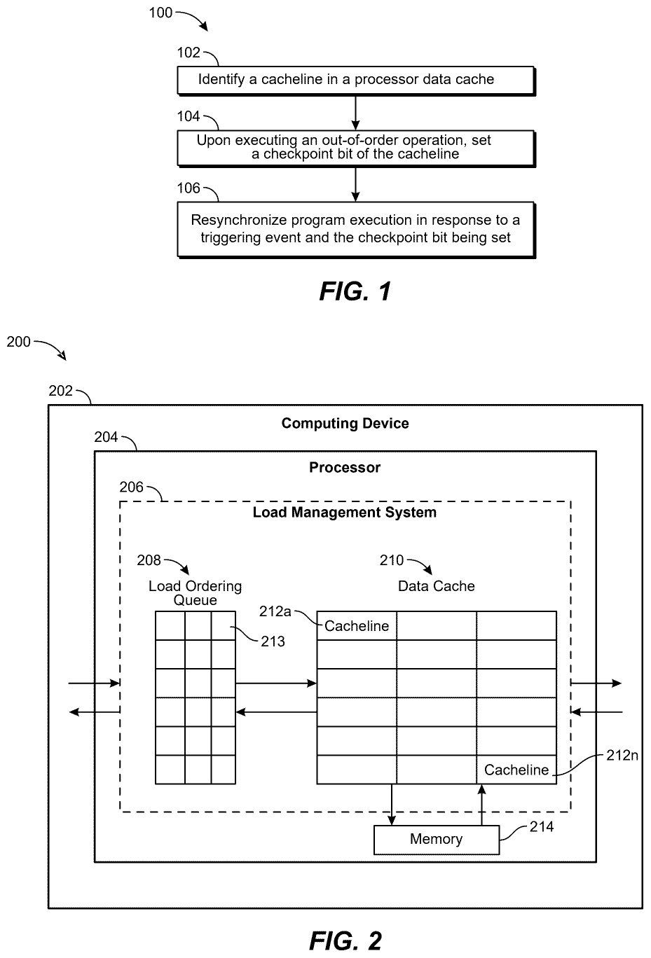

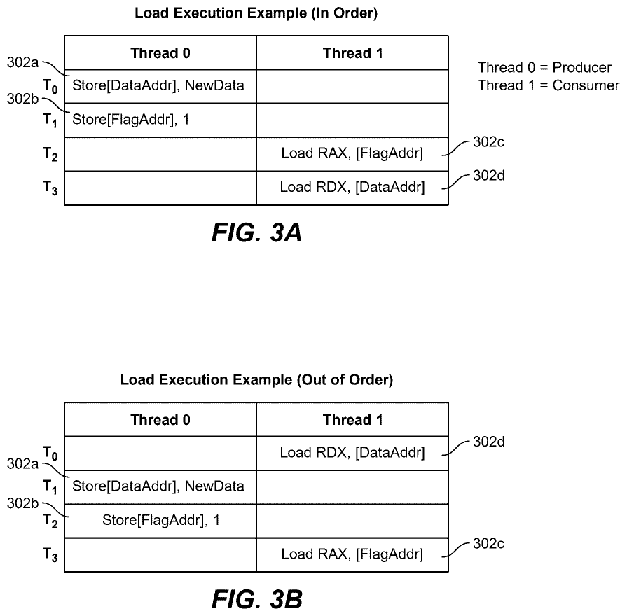

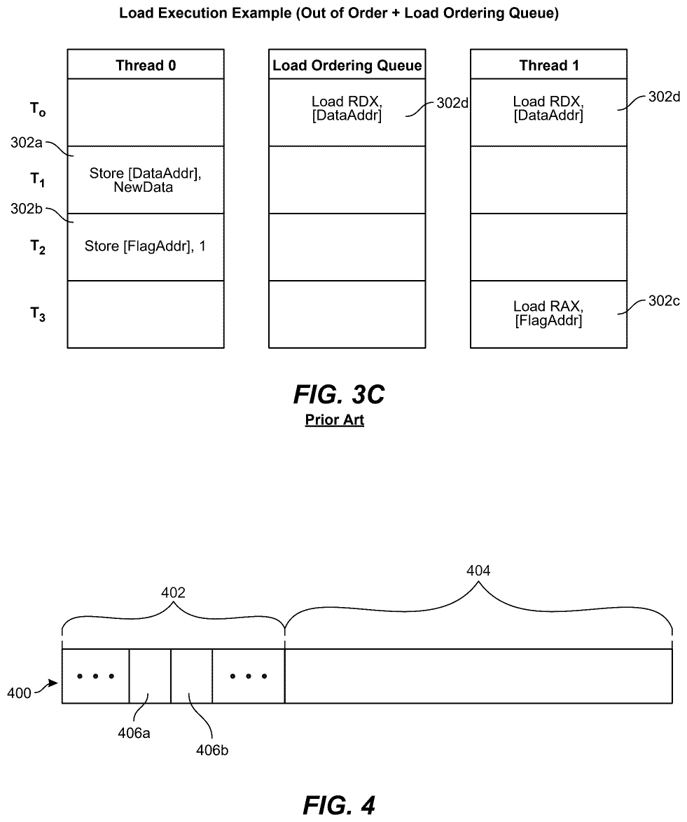

The following will provide, with reference to FIGS. 1-7, detailed descriptions of example systems for tracking out-of-order load operations using cacheline checkpoint bits. For example, FIG. 1 provides detailed descriptions of corresponding computer-implemented methods for the same. Additionally, FIG. 2 shows an example implementations of a load management systems operating in connection with a processor of a computing device. To provide additional context for the solutions provided by the load management system, FIGS. 3A-3C illustrate how one or more example systems can utilize a load ordering queue. The remaining FIGS. 4-7 illustrate how the load management system solves the problems experienced by example systems utilizing checkpoint bits within cachelines to track out-of-order load operations in both active cachelines and evicted cachelines.

FIG. 1 is a flow diagram of an example computer-implemented method 100 for tracking out-of-order load operations utilizing data cache tags. The steps shown in FIG, 1 can be performed by any suitable computer-executable code and/or computer hardware. In one example, each of the steps shown in FIG. 1 can represent an algorithm whose structure includes and/or is represented by multiple sub-steps, examples of which will be provided in greater detail below.

As illustrated in FIG. 1, at step 102 one or more of the systems described herein can identify, in a processor data cache and during program execution, a cacheline that includes at least a first checkpoint bit and a second checkpoint bit. For example, one or more of the systems described herein can access a cacheline that includes at least a first processor operation, a second processer operation, a first checkpoint bit, and a second checkpoint bit. In one or more implementations, the first processor operation can include a load operation, and the second processor operation can include another load operation.

As further illustrated in FIG. 1, at step 104 one or more of the systems described herein can set one of the first checkpoint bit or the second checkpoint bit of the cacheline based on a second processor operation accessing the cacheline out of order from a first processor operation. For example, one or more of the systems described herein can set the second checkpoint bit of the cacheline upon executing the second processor operation out of order from the first processor operation. To illustrate, the first processor operation can be first in program order before the second processor operation. In some implementations, one or more of the systems described herein can execute the second processor operation before the first processor operation (e.g., to utilize processor more efficiently resources). Because of this out-of-order load execution, one or more of the systems described herein can set one of the checkpoint bits to indicate that there is at least one out-of-order load operation associated with the cacheline. As such, that out-of-order load execution may have loaded incorrect data.

Further, as shown in FIG. 1, at step 106 one or more of the systems described

herein can resynchronize program execution in response to a triggering event and at least one of the first checkpoint bit or the second checkpoint bit being set. For example, one or more of the systems described herein can detect a triggering event such as an invalidating probe (e.g., caused by a different core or thread storing data to a memory address from which a previous out-of-order operation loaded). After detecting such a triggering event relative to the cacheline, one or more systems described herein can further read the tag from the cacheline to determine whether any of the two checkpoint bits are set. In response to further determining that at least one checkpoint bit is set, one or more of the systems described herein can further resynchronize program execution by re-executing all operations that have been executed but have not yet been retired (e.g., starting with the oldest load operation). Thus, for example, one or more of the systems described herein can re-execute a previous out-of-order load operation relative to a memory location that now has updated data stored to it.

In one or more implementations, the systems and methods described herein reference many terms and phrases. For example, the term “processor,” as used herein, can refer to a machine that processes information. An example of a processor can include, without limitation, a central processing unit (CPU) of a computer. For example, processors can process instructions that drive a computing device (e.g., a laptop computer, a desktop computer, a mobile computing device, a smart wearable device). In one or more implementations, a processor can include logic circuitry (e.g., and gates, or gates, nor gates, xor gates, arithmetic logic units), data buses, data storage devices (e.g., flash memories), etc. A computing device can include one or more processors, and in some implementations, multiple processors within the same device can work in concert.

In one or more implementations, the terms “processor data cache” or “data cache” can refer to a data layer implemented by or associated with a processor. For example, a data cache can include a plurality of storage registers or dedicated data storage units that can store information. In at least one implementation, a data cache can store information that is copied from a main memory of the processor for faster processing (e.g., due to being close to the processor core). For example, a data cache can store data in a manner that is fully associative, N-way set associative, or directly mapped. Some data caches can allow for speculative execution of operation within a cacheline of the data cache.

As used herein, the term “cacheline” can refer to a data entry within the data cache. For example, a cacheline can be a memory block that holds data in a predetermined layout. To illustrate, a cacheline can have multiple segments or fields dedicated to different types of information. Each of the cacheline fields can store a number of bytes, and each byte can include a number of bits. As such, a cacheline can have a size that depends on the number of fields within the cacheline, a number of bytes within each field, and a number of bits in each byte. In one or more implementations, a bit can be the smallest unit of memory and can store binary information (e.g., a 1 or a 0).

In one or more implementations, bits of a cacheline can be set, re-set, and flash cleared. As used herein, the term “set” can refer to the act of changing a binary bit from 0to 1. Conversely, the term “re-set” can refer to the act of changing a binary bit from 1 to 0. In at least one implementation, a bit can be re-set as the result of a flash clear. For example, a flash clear can apply a voltage to the bit that causes the current value of the bit (e.g., 1) to be erased.

As mentioned above, cachelines can include multiple fields. One such field (e.g., as will be discussed in greater detail below with regard to FIG. 4) can include operational instruction data. For example, this operational instruction data can include multiple operation instructions for operations such as store operations and load operations. In one or more implementations, the term “execute” can refer to the process by which a processor performs the instructions in any given operation directed by a cacheline in the data cache. As an example, the processor can execute a load operation by locating a memory location indicated by the load operation and reading out any data stored at that memory location. When an operation is executed out of order, that operation can be referred to as “executed” or “pending.” As execution of the operation progresses and passes the point where that operation would have been executed had it been executed in order, the operation can be referred to as “retired.”

As used herein, the terms “load ordering queue” (“LOQ”) or “load queue” (“LDQ”) can refer to a microprocessor data structure associated with processor load operations. For example, in some implementations as mentioned above, example load management system can use an LOQ or LDQ to track out-of-order load operations. In one or more implementations, an LOQ or LDQ can include an amount of dedicated memory or registers that operates in a first-in-first-out manner. In additional implementations, an LOQ may be implemented in any suitable way.

As used herein, the term “agent in the system,” “system agent,” or “another agent in the system” can refer to a thread, component, or operation originating outside of the systems and methods discussed herein. For example, another agent in the system can be a program execution thread from another CPU core.

The systems and methods described herein can be implemented in a variety of ways. For example, as shown in FIG. 2, an implementation 200 of these systems and methods can include a load management system 206 operating within a processor 204 within a computing device 202. As will be discussed in greater detail below, the load management system 206 can operate in connection with a load ordering queue 208 and a data cache 210. In one or more implementations, the processor 204 can further include a memory 214.

The computing device 202 generally represents any type or form of computing device capable of reading computer-executable instructions. Additional examples of the computing device 202 can include, without limitation, laptops, tablets, desktops, servers, cellular phones, personal digital assistants (PDAs), multimedia players, embedded systems, wearable devices (e.g., smart watches, smart glasses), smart vehicles, so-called Internet-of-Things devices (e.g., smart appliances), gaming consoles, variations or combinations of one or more of the same, or any other suitable computing device.

In one or more implementations, the processor 204 can include one or more physical microprocessors. For example, the processor 204 generally represents any type or form of hardware-implemented processing unit capable of interpreting and/or executing computer-readable instructions. In one example, the processor 204 can access and/or access, modify, and/or execute instructions stored in the memory 214 and/or data cache 210. Examples of the processor 204 can include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, or any other suitable physical processor.

As mentioned above, the load management system 206 can perform various acts in connection with the load ordering queue 208 and the data cache 210. In one or more implementations, the load ordering queue 208 and the data cache 210 can be memory structures within the processor 204. In at least one implementation, the data cache 210 can hold one or more cachelines (e.g., cachelines 212a-212n). For example, in at least one implementation, the data cache 210 can be 64 indexes 12 ways for 768 cacheline entries. The load ordering queue can track a number of operations.

Moreover, in some implementations, the load ordering queue 208 can track cacheline addresses of load operations (e.g., such as the cacheline address 213). Additionally, in some implementations, the load ordering queue 208 can track cacheline addresses and checkpoint bits of cachelines that have been evicted from the data cache 210. Additionally, the load ordering queue 208 can track or hold additional information such as retire tags (e.g., RetTags) that identify load operations and identifies if they have executed out of order. In at least one implementation, the load ordering queue 208 can track up to 96 operations or cachelines.

Additionally, as shown in FIG. 2, the processor 204 can include the memory 214. In one or more implementations, the memory 214 generally represents any type or form of volatile or non-volatile storage device or medium capable of storing data and/or computer-readable instructions. In one example, the memory 214 can store, load, and/or maintain data which can then be copied into one or more cachelines. In one or more implementations, the processor 204 can move or copy data from the memory 214 to the data cache 210 for faster execution and processing. Examples of the memory 214 can include, without limitation, random access memory (RAM), read only memory (ROM), flash memory, hard disk drives (HDDs), solid-state drives (SSDs), optical disk drives, caches, variation or combinations of one or more of the same, or any other suitable storage memory.

As mentioned above, example load management systems utilize a load ordering queue (LOQ) to track out-of-order load execution. FIGS. 3A, 3B, and 3C illustrate how such example load management systems conventionally utilize an LOQ. For example, FIG. 3A shows a typical in-order load execution example, while FIG. 3B shows an out-of-order load execution example that results in a load ordering violation. FIG. 3C shows how an example load management system might use an LOQ to remedy such a load ordering violation.

In more detail, FIG. 3A shows an in-order load execution example where the memory address “FlagAddr” begins with the value 0, and the memory address “DataAddr” holds old data. For example, the processor corresponding to “Thread 0” can execute an operation 302a at timestep 0 that stores “NewData” to the address “DataAddr” in the memory 214. Then at timestep 1, the processor corresponding to “Thread 0” can further execute an operation 302b to store the value 1 at the address “FlagAddr” to indicate new data is available at “DataAddr.”

Following this, the example load management system corresponding to “Thread 1” can execute an operation 302c at timestep 2 from “Thread 1” to load a value from the address “FlagAddr” to determine whether new data is available at “DataAddr.” In response to determining the value at “FlagAddr” is 1, the example load management system can further execute an operation 302d at timestep 3 from “Thread 1” to load the new data from “DataAddr.” In this example, the example load management system executes the operations of “Thread 0” and “Thread 1” (e.g., from the same cacheline) in order. As such, the example illustrated in FIG. 3A features no load ordering violations because the “NewData” loaded by the operation 302d is accurate and up-to-date.

FIG. 3B illustrates the same operations between “Thread 0” and “Thread 1,” where the example load management system has executed at least one operation out of order resulting in a load ordering violation. For example, as shown, the example load management system can execute the operation 302d of “Thread 1” at the timestamp 0. At this point, “DataAddr” contains old data (e.g., as the operation 302a to store “NewData” has yet to execute). As such, the example load management system has committed a load ordering violation with the operation 302d relative to the operation 302c. For instance, the load management system 206 further observes operations 302a and 302b of “Thread 0” at timestamps 1 and 2 to store “NewData” at “DataAddr” and set “FlagAddr” to 1 by receiving invalidating probes on behalf of those stores. Next, the load management system 206 loads “FlagAddr” in the operation 302c at timestep 3. This is a violation, however, because the invalidating probe that was initiated by operation 302c indicates there is new data at “DataAddr” even though the example load management system has instead loaded old data from “DataAddr.”

As mentioned above, example load management systems utilize a load ordering queue (LOQ) to guard against the memory consistency violations resulting from out-of-order load execution. FIG. 3C illustrates how an example load management system can utilize an LOQ to guard against the load ordering violation illustrated in FIG. 3B. For example, in response to determining that the operation 302d was executed out of order with respect to the operation 302c, the example load management system can allocate an entry in the LOQ for the operation 302d. Next, by executing the operation 302a, the processor corresponding to “Thread 0” causes an invalidating probe to “Thread 1.” When “Thread 1” receives the invalidating probe, the example load management system can determine if any entries in the LOQ match the memory address “DataAddr.”

In response to determining that the LOQ entry for the operation 302d matches the memory address “DataAddr,” the example load management system can resynchronize load operations that are younger in program order than the oldest load that did not get illegal data (302c), or the youngest load that did get illegal data (302d). For example, in at least one implementation, the example load management system can resynchronize the operation 302d by executing the operation 302d in order with respect to the operation 302c. At that point, the operation 302d will load the “NewData” from “DataAddr.”

While utilizing the load ordering queue in this manner prevents the inaccuracies that arise from out-of-order load executions, the steps illustrated in FIG. 3C continue to increase the inflexibility and inefficiency of the processor where they are implemented. For example, in many implementations, threads include many more load operations than there is space in the load ordering queue. Accordingly, when the number of pending out-of-order load operations exceeds the size of the LOQ, the processor must allow for various computing resource to idle while the load operations within the LOQ eventually retire, thereby creating more space in the LOQ.

As mentioned above, and as discussed in more detail below, the load management system 206 increases the flexibility and efficiency of a processor by tracking out-of-order load operations by utilizing existing cacheline tags rather than a load ordering queue. FIG. 4 illustrates an example cacheline including checkpoint bits utilized by the load management system 206 to track out-of-order load operations. As discussed above, a processor (e.g., the processor 204 shown in FIG. 2) can utilize a data cache (e.g., the data cache 210 shown in FIG. 2) to store data from a memory (e.g., the memory 214 shown in FIG. 2) in a manner that is more efficiently accessed by the processor core. As such, the cachelines within the data cache can include blocks of data in connection with the memory addresses from the processor memory where the blocks of data are stored. Thus, when the processor runs a program that references the memory addresses, the processor can more quickly and efficiently access the memory data in the data cache based on the memory addresses.

To illustrate, as shown in FIG. 4, an example cacheline 400 can be associated with data loaded out of an address within the memory 214 of the processor 204. In one or more implementations, the cacheline 400 can include a tag field 402 and a data field 404. For example, the tag field 402 can include data (e.g., groups of bits) that reference the memory address from which data in the data field 404 was loaded out of the memory 214. The data field 404 can include data blocks including data accessed by operations such as load operations. The data field 404 can also include data blocks that are either NULL or include data that can be overwritten by store operations. In additional implementations, the cacheline 400 can include additional or alternative fields (e.g., an index field, an offset field).

In at least one implementation, the load management system 206 can use or repurpose two existing bits in the tag field 402 to track out-of-order load operations. For example, as shown in FIG. 4, the load management system 206 can use a checkpoint bit 406a and a checkpoint bit 406b to track whether an out-of-order load operation (e.g., executed by accessing data out of the data field 404) is still pending to avoid load ordering violations associated with the cacheline 400.

In one or more implementations, the checkpoint bits 406a, 406b can each be associated with a particular wrap bit value corresponding to operations that access the data field 404. For example, the load management system 206 can set the first checkpoint bit 406a upon the out-of-order execution of a load operation that is associated with wrap bit value 0. As a new operation is dispatched out of order that is associated with wrap bit value 1, the load management system 206 can set the second checkpoint bit 406b.

In more detail, the load management system 206 can assign a tag to every processor operation to track characteristics and/or data associated with each processor operation during program execution. For example, the load management system 206 can assign a tag to a processor operation including a queue entry number of a reorder buffer. In at least one implementation, the reorder buffer can be finite such that the load management system 206 can “wrap” around the end of the reorder buffer during program execution and begin again at the beginning of the reorder buffer. At this point, the load management system 206 can flip (e.g., reverse) the wrap bit value of the processor operation's tag to differentiate this second usage of that queue entry. In this way, the load management system 206 can utilize wrap bits associated with processor operations to aid in age comparison calculations associated with the processor operations.

As the oldest operation associated with a particular wrap bit value retires, the load management system 206 can flash-clear the corresponding checkpoint bit in the tag field of the cacheline as there can be no out-of-order loads pending that are associated with that checkpoint bit. For example, in at least one implementation, the load management system 206 can utilize an advancing tag (e.g., such as “RetTag”) to determine when the oldest operation associated with a checkpoint bit has retired and is no longer out-of-order. Accordingly, that checkpoint bit can now be available for the next “epoch” associated with the same wrap bit value. In one or more implementations, this periodic clearing of the checkpoint bits allows cachelines with no pending out-of-order load operations to avoid triggering a resynchronization in response to an invalidating probe.

As such, in one or more implementations, the load management system 206 utilizes the checkpoint bits 406a, 406b as a “double buffer” in association with the corresponding cacheline. For example, the load management system 206 can determine that each “epoch” of a particular checkpoint bit lasts from the time that the first operation associated with the corresponding wrap bit value is dispatched for execution, until the last operation associated with the same wrap bit value retires. At that point, the load management system 206 can clear or re-set the checkpoint bit associated with that wrap bit value and can utilize the now re-set checkpoint bit for a new epoch of operations.

In response to determining that the operations associated with a particular cacheline (e.g., the cacheline 400) are retired, the load management system 206 can also clear or re-set both the checkpoint bit 406a and the checkpoint bit 406b. Despite this, in at least one implementation and prior to re-setting the checkpoint bits 406a, 406b, the load management system 206 can determine whether there is a post-retire ordering condition is active. For example, in response to determining that a post-retire ordering condition is active, the load management system 206 can prevent any new out-of-order operations associated with the same wrap bit value to set the corresponding checkpoint bit. Instead, in that implementation, the load management system 206 can allocate an entry in the load ordering queue 208 for the new out-of-order load operation. After the post-retire ordering condition ends or becomes inactive, the load management system 206 can again clear the checkpoint bits of the cacheline to continue tracking out-of-order load operations associated with the cacheline.

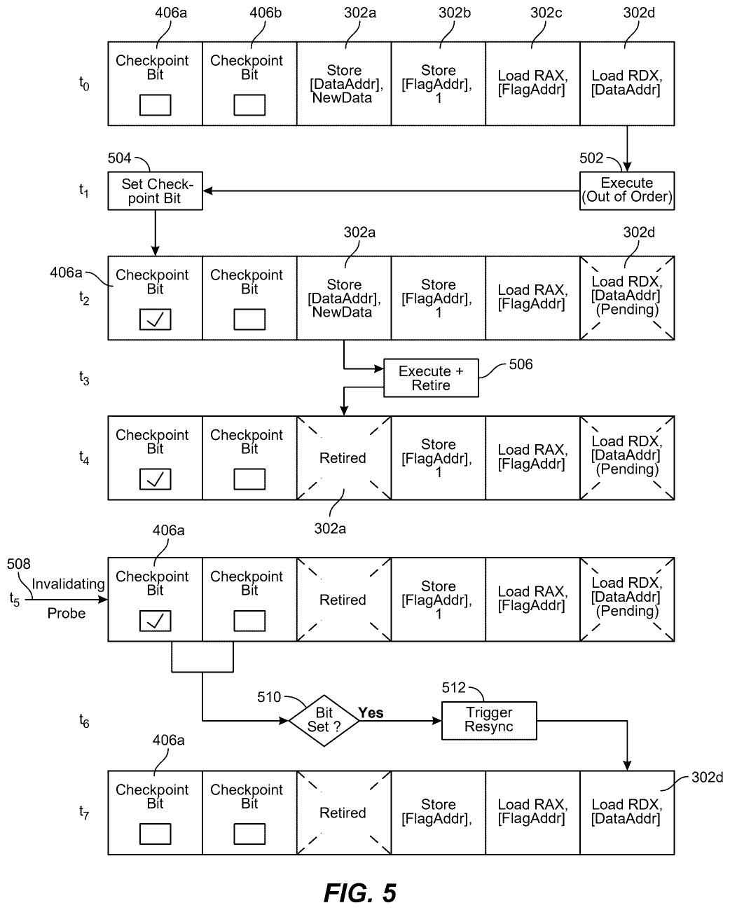

An example method by which the load management system 206 utilizes the checkpoint bits 406a, 406b of the cacheline 400 (e.g., illustrated in FIG. 4) for out-of-order load operation tracking is described in greater detail below. For example, FIG. 5 illustrates a sequence progression diagram of the out-of-order load execution example of FIG. 3C with the load management system 206 utilizing the checkpoint bits 406a, 406b to track out-of-order load operations (e.g., instead of using the load ordering queue 208). As shown, at timestamp 0, the sequence of operations 302a-302d across thread 0 and thread 1 follows the same sequence illustrated in FIG. 3C. In one or more implementations, the checkpoint bits 406a, 406b are associated with the same cacheline that holds the memory addresses “DataAddr” and “FlagAddr.”

At timestamp 1, the load management system 206 can further 1) perform an act 502 by executing the load operation 302d out of order from the load operation 302a, and 2) perform an act 504 of setting a checkpoint bit. In more detail, the load management system 206 can execute the load operation 302d out of order for a variety of reasons. For example, the load management system 206 can execute a load operation out of order in an effort to avoid stalls that occur when data needed to perform a next sequential operation is not available. Despite this, as discussed above, out-of-order executions can cause load ordering violations.

Accordingly, as shown at timestep 2 and upon executing the load operation 302d out of order from the load operation 302c (e.g., first in program order), the load management system 206 can set the checkpoint bit 406a based on an association between the checkpoint bit 406a and the load operation 302d. For example, the load management system 206 can set the checkpoint bit 406a from 0 to 1 to indicate that there is at least one pending (e.g., executed but not retired) load operation associated with the cacheline holding data accessed by the load operation 302d. At timestep 3, the load management system 206 can perform an act 506 by observing the execution of the operation 302a of storing “NewData” to “DataAddr.” Accordingly, as shown at timestamp 4, the load management system 206 can retire the operation 302a. In response to this retirement, however, the operation 302a can trigger an invalidating probe.

In one or more implementations, the operation 302a triggers an invalidating probe because it is a store operation from another agent of the system. For example, the operation 302a can access the cacheline associated with “DataAddr” as part of an execution thread from different processor that the processor 204 (e.g., as shown in FIG. 2), In some implementations, store operations require an exclusive cacheline state for the cachelines they are accessing before committing new data to one or more memory addresses. Accordingly, to ensure that no other operations can access data at “DataAddr”, the operation 302a triggers an invalidating probe 508 at timestep 5.

Thus, at timestep 6 and in response to detecting the invalidating probe 508, the load management system 206 can perform an act 510 by determining whether the checkpoint bit 406a is set. Then, in response to determining that the checkpoint bit 406a is set, the load management system 206 can perform an act 512 of triggering resynchronization of the currently-executing program. For example, the load management system 206 can resynchronize program execution by re-executing all operations that have been executed (e.g., prior to execution of the operation 302a) but have not yet been retired (e.g., starting with the oldest load operation).

In more detail, the load management system 206 can resynchronize program execution by “flushing” the pipeline of pending out-of-order operations. In other words, the load management system 206 can resynchronize program execution by re-executing the load operation that first loaded the incorrect data and then re-executing all later operations that in any way used the incorrect data loaded by that load operation (e.g., later load operations that either directly used the incorrect data or used a value from another operation that directly used the incorrect data). Accordingly, in one or more implementations, the load management system 206 can resynchronize program execution by re-executing operations including operation 302d and any operations that are younger than the older load operation 302d but that have not yet retired. Accordingly, in the example illustrated in FIG. 5, the load management system 206 can re-execute the operation 302d, which will now load the correct data from the address “DataAddr.” Upon resynchronizing program execution, the load management system 206 can further flash clear the checkpoint bit 406a to indicate that there are no pending out-of-order load operations associated with the cacheline 400.

As mentioned above, the load management system 206 can track out-of-order load operations utilizing data cache tags rather than a load ordering queue (e.g., the load ordering queue 208 as shown in FIG. 2). In one or more implementations, the load management system 206 can further repurpose the load ordering queue 208 with regard to evicted cachelines. For example, a cacheline can be evicted from the data cache 210 when the cacheline appears to have operations that have been executed, the data cache 210 is full, and a new cacheline needs to be held in the data cache 210. Under these or other circumstances, the load management system 206 can evict a cacheline that appears to be associated with operations that have all been executed (e.g., one or more of the operations were speculatively executed).

This becomes problematic, however, when any of those apparently executed operations were executed out of order. For example, if a cacheline is evicted with an out-of-order load operation still pending, subsequent operations can be affected by potentially inaccurate data resulting from that out-of-order load operation. Accordingly, the load management system 206 can repurpose the load ordering queue 208 to hold evicted cachelines with pending out-of-order load operations.

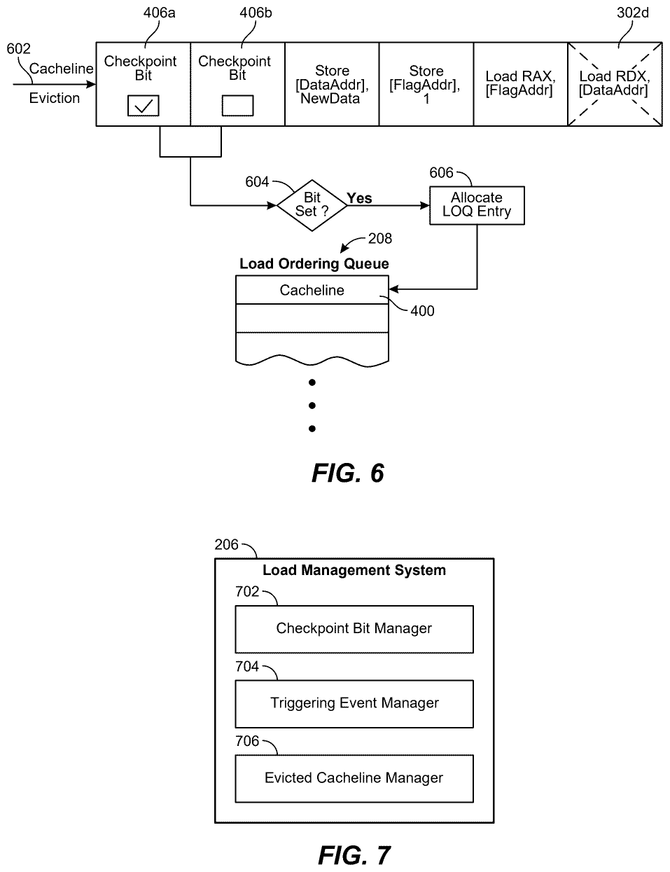

For example, as shown in the sequence progression diagram of FIG. 6, a cacheline (e.g., the cacheline 400 as shown in FIG. 4) can include data that was accessed by the load operation 302d that was executed out-of-order from another load operation (e.g., as at timestep 2 shown in FIG. 5) during program execution. Accordingly, the load management system 206 can set the checkpoint bit 406a to indicate that the cacheline is associated with a pending out-of-order operation. Upon detecting a triggering event including an eviction 602 of that cacheline, the load management system 206 can perform an act 604 of checking whether any of the checkpoint bits (e.g., the checkpoint bit 406a or the checkpoint bit 406b) of that cacheline are set. In response to determining that at least one of the checkpoint bit 406a or the checkpoint bit 406b is set (e.g., “Yes”), the load management system 206 can perform an act 606 of allocating a load ordering queue (LOQ) entry to track that cacheline (e.g., the cacheline 400) in the load ordering queue 208.

In one or more implementations, the load management system 206 can utilize the load ordering queue 208 to track out-of-order load operations relative to the evicted cacheline from that point forward during program execution. For example, in response to a detected store operation from another agent in the system (i.e., that triggers an invalidating probe), the load management system 206 can check the evicted cachelines in the load ordering queue 208 for any operations related to the memory address referenced by the detected store operation. If any of the evicted cachelines include data accessed by a load operation that referenced the same memory address as the memory address referenced by the detected store operation, the load management system 206 can trigger a resynchronization of the program execution.

Although FIGS. 5 and 6 illustrate one example of program execution in connection with the checkpoint bit 406a and the checkpoint bit 406b, other implementations are possible. For example, in some implementations and depending on operation execution within a currently operating program and the corresponding wrap bits, the load management system 206 can set both of the checkpoint bit 406a and the checkpoint bit 406b. Additionally, in some implementations and depending on operation execution within a currently operating program and the corresponding wrap bits, the load management system 206 can set the checkpoint bit 406b but not the checkpoint bit 406a, and vice versa.

Regardless of whether one or both of the checkpoint bits 406a, 406b are set, the load management system 206 can resynchronize program execution in response to determining that either of the checkpoint bits 406a, 406b are set. For instance, in response to first determining that either of the checkpoint bits 406a, 406b are set, the load management system 206 may not assess whether the remaining checkpoint bit is set. Instead, in response to determining that at least one of the checkpoint bits 406a, 406b is set, the load management system 206 can immediately trigger a resynchronization (e.g., in response to an invalidating probe) or an LOQ entry allocation (e.g., in response to a cacheline eviction).

FIG. 7 illustrates a block diagram of the load management system 206 as discussed throughout. As mentioned, the load management system 206 performs many functions in connection with tracking out-of-order load operations utilizing data cache tags. Accordingly, FIG. 7 provides additional detail with regard to these functions. For example, as shown in FIG. 7, the load management system 206 can operate as software, firmware, or as a logic layer within the processor 204. In one or more implementations, the load management system 206 can include a checkpoint bit manager 702, a triggering event manager 704, and an evicted cacheline manager 706. Although illustrated as separate elements, one or more of the components 702-706 of the load management system 206 can be combined in additional implementations. Similarly, in additional implementations, the load management system 206 can include additional, fewer, or different components.

In certain implementations, the load management system 206 can represent one or more software applications or programs that, when executed by a processor, can cause the processor to perform one or more tasks. For example, and as will be described in greater detail below, one or more of the components 702-706 of the load management system 206 can represent software stored and configured to run on one or more computing devices. One or more of the components 702-706 of the load management system 206 shown in FIG. 7 can also represent all or portions of one or more special-purpose computers configured to perform one or more tasks.

As mentioned above, and as shown in FIG. 7, the load management system 206 can include the checkpoint bit manager 702. In one or more implementations, the checkpoint bit manager 702 sets and re-sets checkpoint bits (e.g., the checkpoint bits 406a, 406b) depending on the execution and retirement of operations associated with a cacheline that includes those checkpoint bits. For example, the checkpoint bit manager 702 can determine a wrap bit value (e.g., an operation's “RetTag” wrap bit value) associated with a load operation that is executing out of order from another load operation. The checkpoint bit manager 702 can then set the checkpoint bit corresponding to that wrap bit value within the tag of the associated cacheline. In response to determining that processing of the operations in the cacheline have moved past where that load operation would have been executed in order, the checkpoint bit manager 702 can determine that the load operation is retired and re-set the checkpoint bit. By setting and re-setting the checkpoint bits 406a, 406b based on the load operation's associated wrap bit value, the checkpoint bit manager 702 can effectively implement a double-buffered system of tracking out-of-order load operations utilizing the checkpoint bits 406a, 406b.

As mentioned above, and as shown in FIG. 7, the checkpoint bit manager 702 can include the triggering event manager 704. In one or more implementations, the triggering event manager 704 can detect and respond to triggering events relative to the data cache 210. For example, the triggering event manager 704 can detect an invalidating probe relative to a particular cacheline in the data cache. In response to detecting the invalidating probe, the triggering event manager 704 can determine whether any of the checkpoint bits associated with that cacheline are set (e.g., whether any of the checkpoint bits have a value of 1). If any of the checkpoint bits are set, the triggering event manager 704 can resynchronize program execution.

For example, the triggering event manager 704 can resynchronize program execution by identifying the oldest load operation associated with the wrap bit value corresponding to the checkpoint bit that is set. The triggering event manager 704 can then re-execute the identified load operation, and every younger operation that follows.

Additionally, the triggering event manager 704 can detect other triggering events. For example, the triggering event manager 704 can detect an eviction of a cacheline. To illustrate, in response to detecting the eviction of a cacheline, the triggering event manager 704 can determine whether any of the checkpoint bits associated with the evicted cacheline are set. If at least one of the checkpoint bits is set, the triggering event manager 704 can allocate space for tracking the evicted cacheline in the load ordering queue 208.

As further shown in FIG. 7, and as mentioned above, the load management system 206 can include the evicted cacheline manager 706. In one or more implementations, the evicted cacheline manager 706 can process and track evicted cachelines including pending out-of-order load operations utilizing the load ordering queue 208. For example, in response to the triggering event manager 704 detecting an invalidating probe, the evicted cacheline manager 706 can check evicted cacheline entries in the load ordering queue 208 for a memory address that is the same as the memory address referenced by the invalidating probe. If an identified cacheline in the load ordering queue 208 is associated with a memory location that is the same as the memory location referenced by the invalidating probe, the evicted cacheline manager 706 can resynchronize program execution.

Thus, as described throughout, the load management system 206 presents a flexible and efficient solution to the inaccuracies that can arise due to out-of-order load operations. For example, the load management system 206 efficiently and effectively enforces accurate load ordering utilizing checkpoint bits within cachelines of the data cache 210. The load management system 206 is efficiently implemented because it utilizes existing bits within cacheline tags to track out-of-order load operations.

As such, when a store operation triggers an invalidating probe relative to the data cache (e.g., meaning that new data has been written to an existing memory location), the load management system 206 ensures that all previous load operations that were executed out of order did not load data from the same memory location. If a previous out-of-order load operation did load data from that memory location, the load management system 206 can resynchronize program execution to ensure that all of the load operations are accessing correct data. The load management system 206 can further ensure that out-of-order load operations are correct even if their associated cacheline is evicted from the data cache by repurposing the load ordering queue 208 specifically for evicted cachelines. Accordingly, the load management system 206 flexibly and efficiently minimizes the use of the inflexible load ordering queue 208 to instead guard against load ordering violations utilizing existing cacheline bits.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of the load management system 206 in FIGS. 1-7 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
identifying, in a processor data cache and during program execution, a cacheline comprising at least a first tag field bit repurposed as a first checkpoint bit and a second tag field bit repurposed as a second checkpoint bit, wherein the first checkpoint bit and the second checkpoint bit are associated with respective bit values that include one or more queue entry numbers of a reorder buffer;
setting one of the first checkpoint bit or the second checkpoint bit of the cacheline based on a second processor operation accessing the cacheline out of order from a first processor operation; and
resynchronizing the program execution in response to a triggering event and at least one of the first checkpoint bit or the second checkpoint bit being set.

2. The computer-implemented method of claim 1, further comprising, prior to resynchronizing the program execution, allocating a load ordering queue entry for the cacheline based on the triggering event being an eviction of the cacheline from the processor data cache, and at least one of the first checkpoint bit or the second checkpoint bit being set.

3. The computer-implemented method of claim 1, wherein:
the cacheline is accessed by additional processor operations;
the first processor operation and a first subset of the additional processor operations are associated with a first wrap bit value; and
the second processor operation and a second subset of the additional processor operations are associated with a second wrap bit value.

4. The computer-implemented method of claim 3, further comprising re-setting at least one of the first checkpoint bit or the second checkpoint bit based on retirement of the second processor operation and at least one of the first checkpoint bit or the second checkpoint bit being associated with the second processor operation.

5. The computer-implemented method of claim 4, wherein the second processor operation is retired based on a wrap bit value associated with the second processor operation.

6. The computer-implemented method of claim 5, further comprising:
executing an additional processor operation from the first subset of the additional processor operations out of order; and
setting the first checkpoint bit of the cacheline based on the additional processor operation from the first subset of the additional processor operations being associated with the first checkpoint bit.

7. The computer-implemented method of claim 6, further comprising:
executing an additional processor operation from the second subset of the additional processor operations out of order;
setting the second checkpoint bit of the cacheline; and
re-setting the second checkpoint bit of the cacheline upon retirement of the additional processor operation from the second subset of the additional processor operations.

8. The computer-implemented method of claim 1, wherein resynchronizing the program execution comprises re-executing the second processor operation.

9. The computer-implemented method of claim 1, wherein the triggering event is an invalidating probe.

10. The computer-implemented method of claim 1, wherein the respective bit values correspond to respective wrap bit values that include the one or more queue entry numbers of the reorder buffer and that are flipped to differentiate second usages of reorder buffer queue entries from first usages of reorder buffer queue entries.

11. A processor comprising:
a processor data cache that includes a cacheline comprising at least a first tag field bit repurposed as a first checkpoint bit and a second tag field bit repurposed as a second checkpoint bit, wherein the first checkpoint bit and the second checkpoint bit are associated with respective bit values that include one or more queue entry numbers of a reorder buffer; and
a logic layer circuit that causes the processor to:
identify, in the processor data cache and during program execution, the cacheline;
set one of the first checkpoint bit or the second checkpoint bit of the cacheline based on a second processor operation accessing the cacheline out of order from a first processor operation; and
resynchronize the program execution in response to a triggering event and at least one of the first checkpoint bit or the second checkpoint bit being set.

12. The processor of claim 11, wherein the logic layer circuit of the processor further causes the processor to, prior to resynchronizing the program execution, allocate a load ordering queue entry within a load ordering queue for the cacheline based on the triggering event being an eviction of the cacheline from the processor data cache, and at least one of the first checkpoint bit or the second checkpoint bit being set.

13. The processor of claim 12, wherein the logic layer circuit of the processor further causes the processor to:
re-set the first checkpoint bit and the second checkpoint bit of the cacheline following retirement of the second processor operation; and
de-allocate the load ordering queue entry for the cacheline within the load ordering queue.

14. The processor of claim 11, wherein:
the cacheline is accessed by additional processor operations;
the first processor operation and a first subset of the additional processor operations are associated with a first wrap bit value; and
the second processor operation and a second subset of the additional processor operations are associated with a second wrap bit value.

15. The processor of claim 14, wherein the logic layer circuit of the processor further causes the processor to re-set at least one of the first checkpoint bit or the second checkpoint bit based on retirement of the second processor operation and at least one of the first checkpoint bit or the second checkpoint bit being associated with the second processor operation.

16. The processor of claim 15, wherein the logic layer circuit of the processor further causes the processor to:
Execute an additional processor operation from the first subset of the additional processor operations out of order; and
set the first checkpoint bit of the cacheline based on the additional processor operation from the first subset of the additional processor operations being associated with the first checkpoint bit.

17. The processor of claim 16, wherein the logic layer circuit of the processor further causes the processor to:
execute an additional processor operation from the second subset of the additional processor operations out of order;
set the second checkpoint bit of the cacheline based on the additional processor operation from the second subset of the additional processor operations being associated with the second checkpoint bit; and
re-set the second checkpoint bit of the cacheline upon retirement of the additional processor operation from the second subset of the additional processor operations.

18. The processor of claim 11, wherein resynchronizing the program execution comprises re-executing the second processor operation.

19. The processor of claim 11, wherein the triggering event relative to the cacheline is an invalidating probe.

20. A system comprising:
at least one processor; and
physical memory comprising computer-executable instructions that, when executed by the at least one processor, cause the at least one processor to perform acts comprising:
identifying, in a processor data cache and during program execution, a cacheline comprising at least a first tag field bit repurposed as a first checkpoint bit and a second tag field bit repurposed as a second checkpoint bit, wherein the first checkpoint bit and the second checkpoint bit are associated with respective bit values that include one or more queue entry numbers of a reorder buffer;
setting one of the first checkpoint bit or the second checkpoint bit of the cacheline based on a second processor operation accessing the cacheline out of order from a first processor operation; and
resynchronizing the program execution in response to a triggering event and at least one of the first checkpoint bit or the second checkpoint bit being set.
